(19) United States
(12) Patent Application Publication
(10) Pub. No.: US 2025/0102786 A1
(43) Pub. Date: Mar. 27, 2025

(54) OPEN-TOP TWO-PHOTON LIGHT SHEET MICROSCOPE AND OPERATING METHOD THEREOF

(71) Applicants: POSTECH RESEARCH AND BUSINESS DEVELOPMENT FOUNDATION, Pohang-si (KR); THE ASAN FOUNDATION, Seoul (KR); FOUNDATION FOR INDUSTRY COOPERATION UNIVERSITY OF ULSAN, Ulsan (KR)

(72) Inventors: Ki Hean KIM, Pohang-si (KR); Won Yeong PARK, Pohang-si (KR); Su Il JEON, Pohang-si (KR); Seung-Mo HONG, Seoul (KR); Jinho SHIN, Seoul (KR)

(73) Assignees: POSTECH RESEARCH AND BUSINESS DEVELOPMENT FOUNDATION, Pohang-si (KR); THE ASAN FOUNDATION, Seoul (KR); FOUNDATION FOR INDUSTRY COOPERATION UNIVERSITY OF ULSAN, Ulsan (KR)

(21) Appl. No.: 18/817,025

(22) Filed: Aug. 27, 2024

(30) Foreign Application Priority Data
Sep. 27, 2023 (KR) 10-2023-0130841

(51) Int. Cl. G02B 21/00; G01N 21/64; G02B 21/08

(52) U.S. Cl. CPC G02B 21/0076; G01N 21/6458; G02B 21/0048; G02B 21/08; G01N 2021/6463; G01N 2201/06113; G01N 2201/105

(57) ABSTRACT

Disclosed are an open-top two-photon light sheet microscope and an operating method thereof. The open-top two-photon light sheet microscope is capable of obtaining high-depth imaging, high-contrast resolution, and double contrast based on a Bessel beam, and enables rapid three-dimensional imaging by continuously capturing tissue on a per-plane basis without an optical clearing process or a sectioning process, and an operating method thereof.

### CROSS REFERENCE TO RELATED APPLICATION

The present application claims priority to Korean Patent Application No. 10-2023-0130841, filed Sep. 27, 2023, the entire contents of which are incorporated herein for all purposes by this reference.

National Research and Development Project Supporting the Present Disclosure
Project Serial Number: 1711161876
Project Number: 2020R1A2C3009309
Ministry Name: Ministry of Science, Technology and Innovation
Project Management (Specialized) Institution: National Research Foundation of Korea
Research Business: Individual basic research (Ministry of Science, Technology and Innovation)
Research Topic: Development of high-speed, high-definition microscope available for use in clinical trials and real-time image analysis method
Contribution Ratio: 1/1
Project Performing Institution: Pohang University of Science & Technology
Research Period: From Mar. 1, 2022 to Feb. 28, 2023

### BACKGROUND OF THE INVENTION

### Field of the Invention

The present disclosure relates generally to an open-top two-photon light sheet microscope and an operating method thereof. More particularly, the present disclosure relates to an open-top two-photon light sheet microscope which is capable of obtaining high-depth imaging, high-contrast resolution, and double contrast based on a Bessel beam, and enables rapid three-dimensional imaging by continuously capturing tissue on a per-plane basis without an optical clearing process or a sectioning process, and an operating method thereof.

### Description of the Related Art

Generally, an open-top light sheet microscope is used for the 3D imaging method of irradiating tissue with a 2D laser sheet and capturing images thereof on a per-plane basis, and the imaging method uses a method of high-speed imaging of the tissue while transporting the tissue with the tissue placed on a microscope stage without a sectioning process after simple fluorescent staining of cells.

The open-top light sheet microscope is an open-top type in which all optical components are located under the stage, enabling imaging tissue on a per-plane basis by irradiating a sample with a two-dimensional light sheet without any restrictions on the size of the tissue.

Meanwhile, short-wavelength single-photon excitation light is used for fluorescence imaging, and accordingly, in an opaque tissue, images can be acquired only in shallow regions near a surface thereof due to the scattering and absorption of light.

In this case, in order to perform 3D imaging to a deep region of the tissue, the optical clearing step of the tissue is required, and this requires a lot of time, making it difficult to perform a rapid biopsy.

### Document of Related Art

(Patent Document 1) Korean Patent Application Publication No. 10-2022-0115947 (Invention title: OPEN-TOP LIGHT-SHEET MICROSCOPY WITH NON-ORTHOGONAL ARRANGEMENT OF ILLUMINATION OBJECTIVE AND COLLECTION OBJECTIVE, published on Nov. 13, 2020)

### SUMMARY OF THE INVENTION

Accordingly, the present disclosure has been made to solve the above problems occurring in the related art, and the present disclosure is intended to propose an open-top two-photon light sheet microscope which includes a laser irradiation part that irradiates a sample with a two-photon excitation laser, and an image acquisition part that receives a two-photon fluorescence signal and a second harmonic signal generated by the irradiating laser so that high-ratio three-dimensional imaging of the sample can be processed at high speed without a sectioning process or an optical clearing process, and an operating method thereof.

The purposes of the present disclosure are not limited to the purpose mentioned above, and other purposes not mentioned may be clearly understood by those skilled in the art from the description below.

In order to achieve the objectives of the present disclosure, there is provided an open-top two-photon light sheet microscope including: a laser irradiation part configured to irradiate a sample with a two-photon excitation laser beam; and an image acquisition part configured to receive a two-photon fluorescence signal and a second harmonic signal generated by the irradiating laser beam, wherein the laser irradiation part comprises a single Bessel beam generation part configured to generate a single Bessel beam or a multiple Bessel beam generation part configured to generate multiple Bessel beams.

In addition, here, the laser irradiation part may include a first objective lens, and the image acquisition part may include a second objective lens, wherein the first objective lens and the second objective lens may be orthogonal to each other.

In addition, here, the laser irradiation part may include a first objective lens, and the image acquisition part may include a second objective lens, wherein the first objective lens and the second objective lens may be arranged to be non-orthogonal to each other.

In addition, here, the single Bessel beam generation part may include: a light source part configured to generate a laser beam; an axicon lens configured to convert the laser beam generated from the light source part into the single Bessel beam; and a y-direction scan mirror configured to generate a Bessel sheet beam by scanning the single Bessel beam converted from the axicon lens in a y direction.

In addition, here, the image acquisition part may include: a dichroic mirror configured to receive a reaction beam generated from the sample and separate the reaction beam into the two-photon fluorescence signal and the second harmonic signal; a two-photon fluorescence signal image acquisition part configured to receive the two-photon fluorescence signal passing through the dichroic mirror; and a second harmonic signal image acquisition part configured to receive the second harmonic signal reflected from the dichroic mirror.

In addition, here, the multiple Bessel beam generation part may include: a light source part configured to generate a laser beam; a first cylindrical lens configured to convert a point-shaped laser beam generated from the light source part into a line-shaped beam; a second cylindrical lens configured to organize the converted line-shaped beam into a collimated beam; a spatial light modulator configured to convert the collimated line-shaped beam into the multiple Bessel beams; and a y-direction scan mirror configured to generate multiple Bessel sheet beams by scanning the converted multiple Bessel beams in a y direction.

In addition, here, the image acquisition part may include: a restoration module configured to restore a tilted image plane of a reaction beam generated from the sample; a dichroic mirror configured to separate the reaction beam passing through the restoration module into the two-photon fluorescence signal and the second harmonic signal; a two-photon fluorescence signal image acquisition part configured to receive the two-photon fluorescence signal passing through the dichroic mirror; and a second harmonic signal image acquisition part configured to receive the second harmonic signal reflected from the dichroic mirror.

In addition, here, the laser irradiation part and the image acquisition part may share one single objective lens.

In addition, here, the laser irradiation part may use only a partial focal region of the single objective lens.

In addition, here, the microscope of the present disclosure may further include: a sample holder configured to hold the sample; and a motorized stage configured to transport the sample holder in an x direction, wherein the sample holder may include a liquid prism to eliminate an off-axis optical aberration.

In addition, according to the present disclosure, there is provided an operating method of the open-top two-photon light sheet microscope, the method including: a laser beam irradiation step of irradiating a sample with a laser beam; and an image acquisition step by an image acquisition part receiving a two-photon fluorescence signal and a second harmonic signal generated by the irradiating laser beam, wherein the laser beam irradiation step includes: a laser beam generation step by a light source part generating a laser beam; a single Bessel beam generation step or a multiple Bessel beam generation step by a single Bessel beam generation part or a multiple Bessel beam generation part converting the laser beam generated in the laser beam irradiation step into a single Bessel beam or multiple Bessel beams; and a scanning step by a y-direction scan mirror configured to generate a single Bessel sheet beam or multiple Bessel sheet beams by scanning the single Bessel beam or the multiple Bessel beams converted in the single Bessel beam generation step or the multiple Bessel beam generation step in a y direction, wherein the image acquisition step includes: an image separation step by a dichroic mirror configured to separate a reaction beam passing through a second objective lens into the two-photon fluorescence signal and the second harmonic signal; a two-photon fluorescence signal image acquisition step by a two-photon fluorescence signal image acquisition part configured to receive the two-photon fluorescence signal passing through the dichroic mirror; and a second harmonic signal image acquisition step by a second harmonic signal image acquisition part configured to receive the second harmonic signal reflected from the dichroic mirror.

The open-top two-photon light sheet microscope and the operating method thereof according to the present disclosure have the following effects.

First, compared to a single-photon-based light sheet microscope, the open-top two-photon light sheet microscope is cable of performing imaging to relatively deep regions and is able to perform faster and more efficient examination than existing two-dimensional pathological tissue examination.

Second, by using long-wavelength two-photon excitation light and Bessel beam scanning with non-diffracting characteristics, the open-top two-photon light sheet microscope is able to perform observation to a deep portion of tissue without being disturbed by the scattering or absorption of light and without reducing resolution despite fluorescence imaging.

Third, by using two image acquisition parts for each wavelength band, the open-top two-photon light sheet microscope is able to simultaneously image a two-photon fluorescence signal and a second harmonic signal, and is able to obtain additional collagen information of an extracellular matrix in addition to cell information, thereby enabling precise analysis of lesions.

The effects of the present disclosure are not limited to the effects mentioned above, and other effects not mentioned may be clearly understood by those skilled in the art from the description of the claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram schematically illustrating the configuration and arrangement of an open-top two-photon light sheet microscope according to a first embodiment of the present disclosure;

FIGS. 2A and 2B are configuration diagrams of an optical system for creating a light sheet by using a single Bessel beam of the open-top two-photon light sheet microscope according to the present disclosure;

FIG. 3 is a diagram schematically illustrating the configuration and arrangement of an open-top two-photon light sheet microscope according to a second embodiment of the present disclosure;

FIGS. 4A and 4B are configuration diagrams of an optical system for creating a light sheet by using multiple Bessel beams of the open-top two-photon light sheet microscope according to the present disclosure;

FIG. 5 is a diagram schematically illustrating the configuration and arrangement of an open-top two-photon light sheet microscope according to a third embodiment of the present disclosure;

FIG. 6 is a diagram schematically illustrating the configuration and arrangement of an open-top two-photon light sheet microscope according to a fourth embodiment of the present disclosure;

FIG. 7 is a configuration diagram of a liquid prism device of the open-top two-photon light sheet microscope according to the present disclosure;

FIGS. 8A and 8B are diagrams illustrating the expression process of the two-photon fluorescence signal and second harmonic signal of the open-top two-photon light sheet microscope according to the present disclosure;

FIG. 9 is a flowchart of the operating method of the open-top two-photon light sheet microscope according to the present disclosure;

FIGS. 10A and 10B are images illustrating an embodiment of a microsphere and human skin tissue obtained by the open-top two-photon light sheet microscope according to the first embodiment of the present disclosure;

FIG. 11 illustrates images of an embodiment of basal cell carcinoma tissue of human skin obtained by using the open-top two-photon light sheet microscope according to the first embodiment of the present disclosure or a conventional histopathological examination method;

FIG. 12 illustrates images of an embodiment of the normal pancreas and premalignant pancreas of a person obtained by using the open-top two-photon light sheet microscope according to the first embodiment of the present disclosure or the conventional histopathological examination method;

FIG. 13 illustrates images of an embodiment of the premalignant pancreas and pancreatic ductal adenocarcinoma tissue of a person obtained by using the open-top two-photon light sheet microscope according to the first embodiment of the present disclosure or the conventional histopathological examination method;

FIG. 14 illustrates images of an embodiment of the benign prostate and prostate adenocarcinoma tissue of a person obtained by using the open-top two-photon light sheet microscope according to the first embodiment of the present disclosure the conventional histopathological examination method; and

FIG. 15 illustrates images of an embodiment of microspheres, human skin tissue, and pancreatic tissue obtained by the open-top two-photon light sheet microscope according to the first embodiment or the third embodiment of the present disclosure.

### DETAILED DESCRIPTION OF THE INVENTION

Advantages and features of the present disclosure, and methods for achieving them, will become clear by referring to embodiments described in detail below along with the accompanying drawings. However, the present disclosure is not limited to the embodiments disclosed below and may be implemented in various different forms. These embodiments are provided solely to ensure that the disclosure of the present disclosure is complete and to fully inform those skilled in the art of the present disclosure of the scope of the invention, and the present disclosure is only defined by the scope of the claims. Like reference numerals refer to like elements throughout the specification.

The sizes and shapes of components shown in the drawings attached to this specification may be exaggerated for clarity and convenience of explanation. It should be noted that the same component may be indicated by the same reference numeral in each drawing. In addition, detailed descriptions of the function and configuration of the disclosed technology that are judged to unnecessarily obscure the gist of the present disclosure may be omitted.

Terms used herein are used to describe specific embodiments and are not intended to limit the present disclosure. As used herein, singular forms include plural forms unless the context clearly indicates otherwise. In addition, throughout this specification, when a part “includes” a certain element, this means that the part may further include other elements unless specifically stated to the contrary.

When a component is described to be “connected” or “joined” to another component, it is understood that the component may be directly connected to or joined to that another component, but still another component may be present therebetween. On the other hand, when a component is described to be “directly connected” or “directly joined” to another component, it should be understood that there are no component therebetween. Other expressions to describe relationships between components should be interpreted in the same manner.

Terms such as an upper end, a lower end, upper surface, lower surface, an upper part, and a lower part, etc. used in this specification are used to distinguish the relative positions of components. For example, for convenience, when the upper side of the drawing is called an upper part and the lower side of the drawing is called a lower part, in reality, the upper part may be named a lower part, and the lower part may be named an upper part, without exceeding the scope of the rights of the present disclosure.

Terms including ordinal numbers, such as “first” and “second”, etc. described in this specification may be used to describe various components, but the components are not limited by the terms. The terms are only used to distinguish each component from another, and are not limited by a manufacturing order, and names thereof may not match in the detailed description and claims of the present disclosure.

All terms, including technical or scientific terms, used in this specification, unless otherwise defined, have the same meanings as commonly understood by those skilled in the art to which the present disclosure pertains. Terms defined in commonly used dictionaries should be interpreted as having meanings consistent with the meanings in the context of the related technology, and unless clearly defined in this specification, should not be interpreted in an idealized or overly formal sense.

Hereinafter, the present disclosure will be described with referent to drawings for describing an open-top two-photon light sheet microscope and an operating method thereof according to an embodiment of the present disclosure.

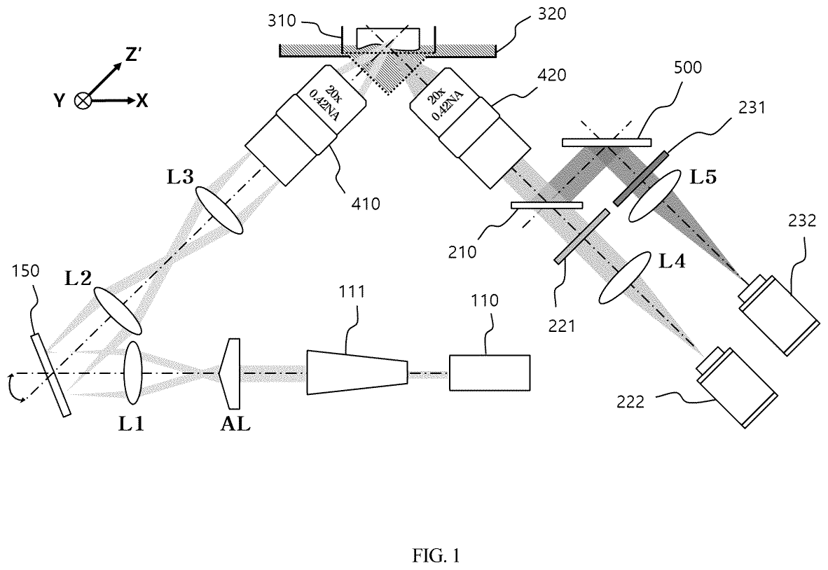

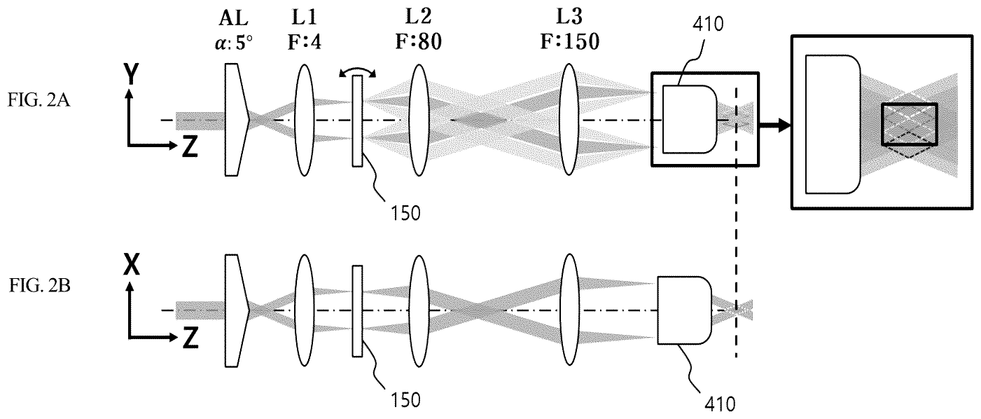

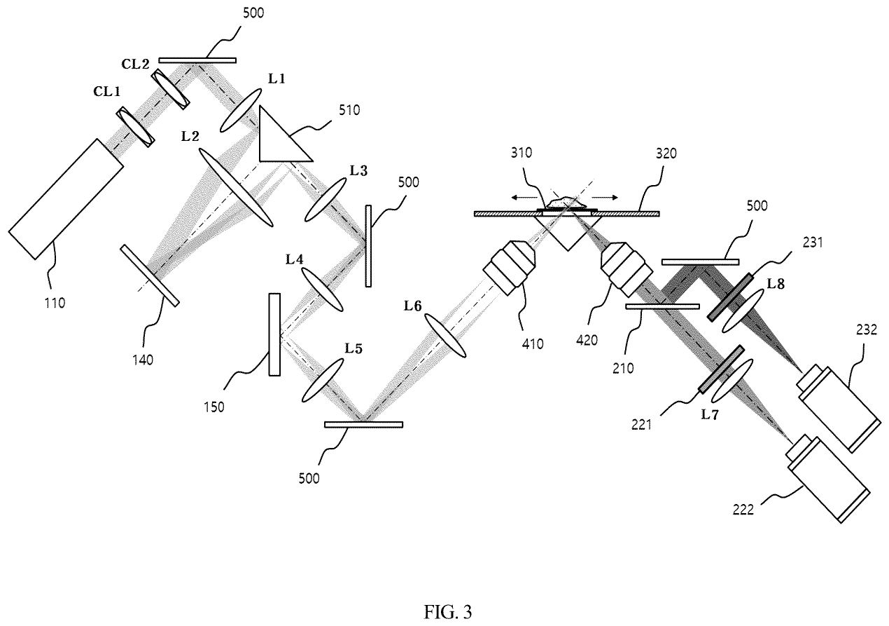

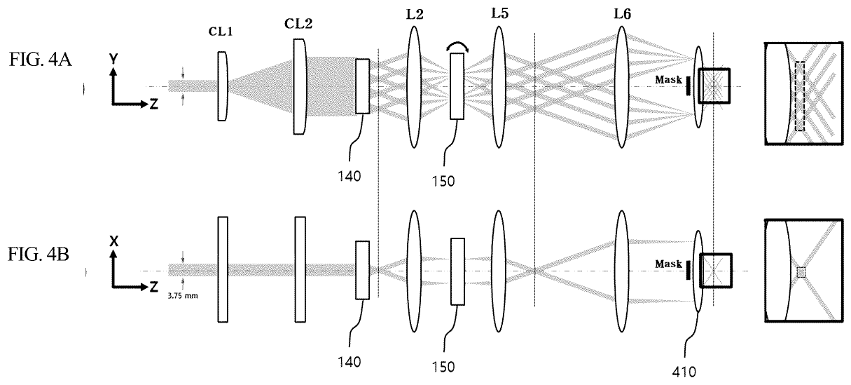

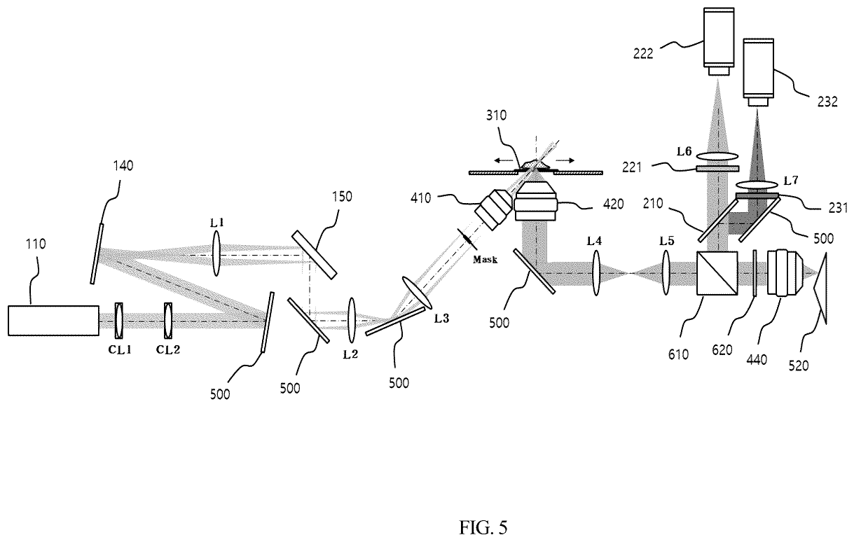

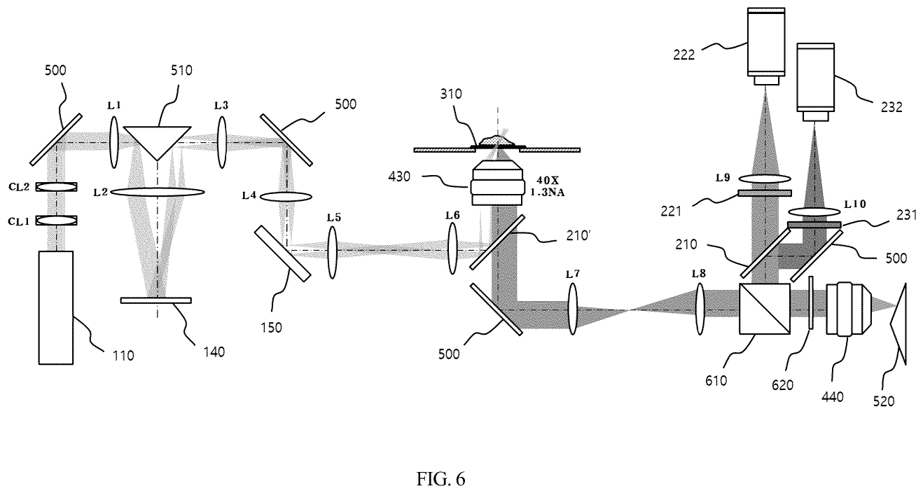

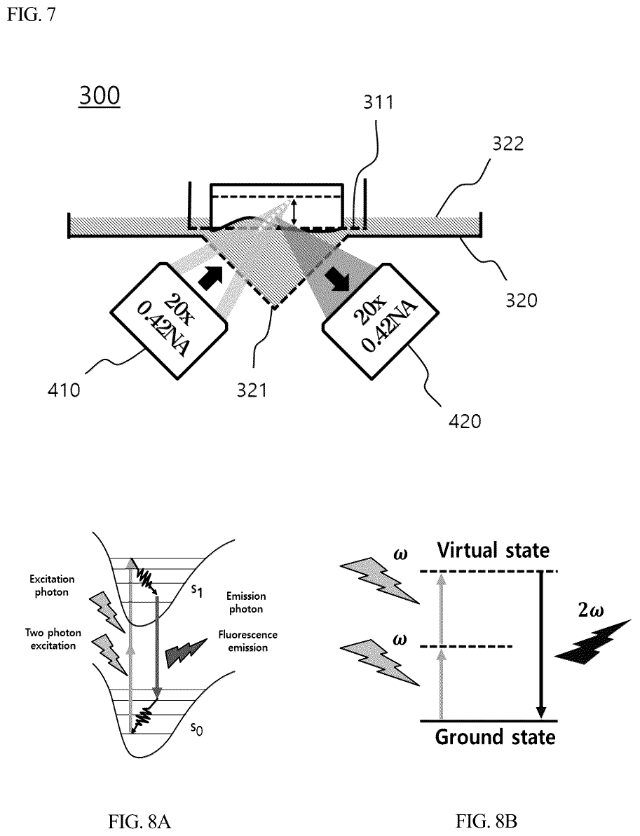

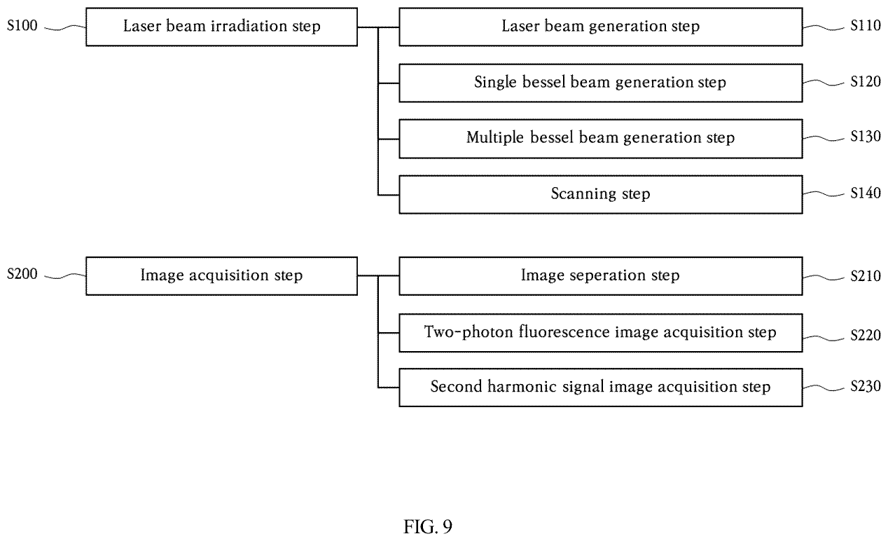

FIG. 1 is a diagram schematically illustrating the configuration and arrangement of an open-top two-photon light sheet microscope according to a first embodiment of the present disclosure, FIGS. 2A and 2B are configuration diagrams of an optical system for creating a light sheet by using a single Bessel beam of the open-top two-photon light sheet microscope according to the present disclosure, FIG. 3 is a diagram schematically illustrating the configuration and arrangement of an open-top two-photon light sheet microscope according to a second embodiment of the present disclosure, and FIGS. 4A and 4B are configuration diagrams of an optical system for creating a light sheet by using multiple Bessel beams of the open-top two-photon light sheet microscope according to the present disclosure. In addition, FIG. 5 is a diagram schematically illustrating the configuration and arrangement of an open-top two-photon light sheet microscope according to a third embodiment of the present disclosure, FIG. 6 is a diagram schematically illustrating the configuration and arrangement of an open-top two-photon light sheet microscope according to a fourth embodiment of the present disclosure, FIG. 7 is a configuration diagram of a liquid prism device of the open-top two-photon light sheet microscope according to the present disclosure, FIGS. 8A and 8B are diagrams illustrating the expression process of the two-photon fluorescence signal and second harmonic signal of the open-top two-photon light sheet microscope according to the present disclosure, and FIG. 9 is a flowchart of the operating method of the open-top two-photon light sheet microscope according to the present disclosure.

The open-top two-photon light sheet microscope according to the present disclosure is a device that enables high-speed, high-resolution three-dimensional imaging by continuously capturing tissue on a per-plane basis deep into the tissue. Referring to FIGS. 1 to 9, four embodiments of the open-top two-photon light sheet microscope according to the present disclosure are described as follows.

FIG. 1 is a diagram schematically illustrating the configuration and arrangement of an open-top two-photon light sheet microscope according to the first embodiment of the present disclosure. Referring to FIG. 1, the open-top two-photon light sheet microscope according to the first embodiment of the present disclosure may include a laser irradiation part 100 that irradiates the sample with a two-photon excitation laser beam, and an image acquisition part 200 that receives a two-photon fluorescence signal and a second harmonic signal generated by the irradiating laser beam.

The laser irradiation part 100 generates a laser beam, converts the laser beam into a single Bessel beam or multiple Bessel beams, and then scans the single Bessel beam or multiple Bessel beams with a scan mirror to irradiate the sample with the single Bessel beam or multiple Bessel beams.

The laser beam with which the sample is irradiated reacts to the sample to form a reaction beam, wherein the reaction beam includes the two-photon fluorescence signal and the second harmonic signal.

Accordingly, the image acquisition part 200 receives the reaction beam generated in response to the sample, separates the reaction beam into the two-photon fluorescence signal and the second harmonic signal, and then acquires each image.

The laser irradiation part 100 generates a single Bessel beam or multiple Bessel beams, and the image acquisition part 200 may acquire a two-dimensional image by scanning the single Bessel beam or multiple Bessel beams generated through the scan mirror. Specifically, for example, referring to FIG. 1, the (single) Bessel beam expands the laser beam in a z′ direction, and the laser beam is scanned through a y-direction scan mirror 150 to obtain a y-z′ image.

As will be described later, by scanning a sample holder 300 in an x direction, the image acquisition part 200 may acquire a three-dimensional image of x-y-z.

The laser irradiation part 100 may include a first objective lens 410, and the image acquisition part 200 may include a second objective lens 420, wherein the first objective lens 410 and the second objective lens 420 may be arranged to be orthogonal to each other.

Referring back to FIG. 1, the first objective lens 410 of the laser irradiation part 100 and the second objective lens 420 of the image acquisition part 200 may be arranged to be orthogonal to each other. The reason is intended to acquire an image in the image acquisition part 200 without distortion in the y-z direction as described above.

Meanwhile, the first objective lens and the second objective lens may be arranged to be non-orthogonal to each other. The first objective lens and the second objective lens may be preferably arranged to have an acute angle, and 45 degrees is the most advantageous arrangement for acquiring an image.

No matter what angle a focal plane is arranged at, the focal plane may be restored by an image restoration module 600, which will be described later. In the above-mentioned example, the focal plane is inclined at 45 degrees, so the focal plane may be restored through the restoration module 600 to be the original focal plane and obtain a 3D image.

As described above, the open-top two-photon light sheet microscope according to the present disclosure may include the sample holder 300 for holding the sample, and may further include a motorized stage 310 for transporting the sample holder 300 in the x direction, and a liquid prism 320 for eliminating off-axis optical aberrations.

The sample holder 300 may hold a tissue sample and transport (scans) the tissue sample in the x-direction to allow a three-dimensional image to be measured, and may function to eliminate off-axis optical aberrations that occur when the first objective lens 410 and the second objective lens 420 described above are orthogonal to each other, that is, when the first objective lens 410 and the second objective lens 420 have a predetermined angle rather than perpendicular to the sample.

The sample holder 300 will be described in detail with reference to FIG. 7 as follows.

The sample holder 300 may include the motorized stage 310 and the liquid prism 320, wherein the motorized stage 310 may include quartz 311, which is a bottom surface for holding a sample.

The motorized stage 310 may be transported in the x-direction as described above, and the sample may be scanned in the x-direction according to the transporting to obtain images. As the motorized stage 310 moves on the liquid prism 320, a laser beam and a reaction beam by the first objective lens 410 and the second objective lens 420 are focused at the same location, and as only the sample moves in the x-direction, each image of the sample in the x-direction may be obtained.

In this case, since the quartz 311 has an angle of 45 degrees to the first objective lens 410 and the second objective lens 420, an off-axis optical aberration is generated by the quartz 311. For this, the liquid prism 320 includes a matching solution 322. The matching solution 322 is provided inside a coverslip 321 and may eliminate the off-axis optical aberration due to the angle of 45 degrees.

The matching solution 322 is a solution for matching the refractive index of the quartz 311, and thus even if the magnification of each of the first objective lens 410 and the second objective lens 420 changes or the size of a sample tissue changes, the configuration of the device is not required to be changed, and the matching solution 322 may be changed depending on a refractive index that requires matching.

The laser irradiation part 100 may include a single Bessel beam generation part 120 that generates a single Bessel beam or a multiple Bessel beam generation part 130 that generates multiple Bessel beams. The first embodiment of FIG. 1 is a case in which the single Bessel beam generation part 120 is included, and the second to fourth embodiments of FIGS. 3, 5, and 6 are cases in which the multiple Bessel beam generation part 130 is included.

FIGS. 2A and 2B are diagrams illustrating the single Bessel beam generation part 120, and FIGS. 4A and 4B are diagrams illustrating the multiple Bessel beam generation part 130. First, the single Bessel beam generation part 120 is described as follows.

Referring to FIG. 1, in FIG. 1, after a light source part 110 generates a laser beam, the laser beam is expanded by a beam expander 111, and the expanded beam is converted into a single Bessel beam by an axicon lens AL. Afterwards, the single Bessel beam is scanned by the y-direction scan mirror 150 to generate a Bessel sheet beam, and a sample is irradiated with the Bessel sheet beam.

Referring to FIGS. 2A and 2B, FIG. 2A illustrates a phenomenon in which a beam is scanned in a y direction when the y-direction scan mirror 150 operates and scans the beam in the y direction, and FIG. 2B is a view seen from a x-z plane, and a portion of a beam scanned in the y direction is not shown.

Referring to FIG. 2A, due to a single Bessel beam, a y-direction scan is performed with a focus expanded in a z-direction (depth), allowing the beam to irradiate to acquire an image in a y-z plane.

Meanwhile, referring to FIGS. 4A and 4B, in the case of multiple Bessel beams, multiple Bessel beams are formed. Multiple Bessel beams are formed in the y direction and sheet beams are generated by the y-direction scan mirror 150, thereby increasing fluorescence efficiency. That is, time for which the Bessel beams stay in the same region is relatively increased, increasing fluorescence efficiency, which makes it possible to obtain clearer images at higher speeds.

That is, referring to FIG. 4A, a first cylindrical lens CL1 may convert a point-shaped beam into a line-shaped beam, and a second cylindrical lens CL2 may organize the line-shaped beam converted by the first cylindrical lens CL1 into a collimated beam so that the line-shaped beam is not dispersed in an undesired direction. Afterwards, the beam is converted into multiple Bessel beams by a spatial light modulator 140, and the converted multiple Bessel beams are generated in the y direction and scanned again with the y-direction scan mirror 150, so that time which the Bessel beams stay in the same portion of the sample irradiated increases, increasing fluorescence efficiency. FIG. 4B is a view viewed in an x-z direction and does not show expansion in the y direction.

Meanwhile, referring back to FIG. 1, the laser irradiation part 100 may include the light source part 110 that generates a laser beam, the axicon lens AL that converts the laser beam generated from the light source part into a single Bessel beam, and the y-direction scan mirror 150 that generates a single Bessel sheet beam by scanning the single Bessel beam converted from the axicon lens AL in the y direction.

The light source part 110 may be a femtosecond pulse laser for generating the laser beam. The femtosecond pulse laser may generate two-photon excitation light with a wavelength approximately twice as long as that of a single-photon excitation-based light source, and this enables the expression of a fluorescence signal based on two-photon excitation and a second harmonic signal.

The two-photon excitation light may be converted into a Bessel sheet beam by the laser irradiation part 100 to form a two-photon light sheet.

Since the two-photon excitation light has a relatively long wavelength, the two-photon excitation light may reduce light scattering in opaque tissues and enables high-depth imaging (the range of 70 to 80 microns based on the skin).

Accordingly, the open-top two-photon light sheet microscope according to the present disclosure may omit an optical clearing process that makes a sample tissue transparent to overcome a shallow imaging depth (the range of 20 to 30 microns based the skin), and thus is able to save time.

The axicon lens AL may allow a laser beam passing therethrough to be focused in the form of a line along an optical axis. That is, the axicon lens AL may convert two-photon excitation light in the form of a Gaussian beam generated from the light source part 110 into a single Bessel beam for the z-axis (or z′-axis) imaging of the sample.

The y-direction scan mirror 150 may perform one-dimensional high-speed scanning of the single Bessel beam converted from the axicon lens AL in the y-axis direction and may convert the single Bessel beam into a single Bessel sheet beam in a two-dimensional z-y axis (or z-y axis).

Meanwhile, referring to FIG. 1, a laser beam generated from the light source part 110 is expanded through the beam expander 111, and the expanded beam enters the axicon lens AL. The specifications of first to third lenses (L1 to L3) are determined according to the arrangement of each component to converge or expand the laser beam according to the path of the laser beam so that the laser beam finally reaches the first objective lens 410.

The image acquisition part 200 may include a dichroic mirror 210 that receives the reaction beam generated from the sample and separates the reaction beam into a two-photon fluorescence signal and a second harmonic signal, a two-photon fluorescence signal image acquisition part 220 that receives the two-photon fluorescence signal passing through the dichroic mirror 210, and a second harmonic signal image acquisition part 230 that receives the second harmonic signal reflected from the dichroic mirror.

The dichroic mirror 210 may separate the reaction beam passing through the second objective lens 420 into the two-photon fluorescence signal and the second harmonic signal. In an embodiment, the dichroic mirror 210 may be a long pass filter, and may allow the two-photon fluorescence signal with a relatively long wavelength to pass therethrough and the second harmonic signal with a relatively short wavelength to be reflected therefrom.

The two-photon fluorescence signal image acquisition part 220 may receive the two-photon fluorescence signal to acquire an image of a two-photon fluorescence signal, and the second harmonic signal image acquisition part 230 may receive the second harmonic signal to acquire a second harmonic signal image.

The two-photon fluorescence signal image acquisition part 220 may include a first bandpass filter 221 and a first camera 222, and the second harmonic signal image acquisition part 230 may include a second bandpass filter 231 and a second camera 232.

The specifications of the dichroic mirror 210, the first bandpass filter 221, and the second bandpass filter 231 may vary depending on the wavelength band of excitation light.

The first camera 222 and the second camera 232 may use a sCMOS camera (Scientific CMOS), which produces lower noise and higher resolution and contrast ratio than a CMOS device.

The intensity of the second harmonic signal is much lower than the two-photon fluorescence signal, and thus when a gain (digital camera setting in which the signal amplification of a camera sensor is controlled) is adjusted, the first camera 222 and the second camera 232 may be replaced with one camera.

FIG. 3 is a diagram schematically illustrating the configuration and arrangement of an open-top two-photon light sheet microscope according to the second embodiment of the present disclosure. Referring to FIG. 3, the laser irradiation part 100 of the open-top two-photon light sheet microscope according to the second embodiment of the present disclosure may include the light source part 110 that generates a laser beam, the first cylindrical lens CL1 that converts the laser beam generated by the light source part 110 from a dot-shaped beam to a line-shaped beam, the second cylindrical lens CL2 that organizes the converted line-shaped beam into a collimated beam, the spatial light modulator 140 that converts the organized line-shaped beam into multiple Bessel beams, and the y-direction scan mirror 150 that generates multiple Bessel sheet beams by scanning the converted multiple Bessel beams in the y-direction.

The first cylindrical lens CL1 may be used to convert a point-shaped beam generated from the light source part 110 into a line-shaped beam, and may be replaced with another device capable of converting the point-shaped beam into the line-shaped beam.

The second cylindrical lens CL2 may convert the line-shaped beam converted by the first cylindrical lens CL1 into a collimated beam so that the converted line-shaped beam is not dispersed in an undesired direction.

Referring to FIG. 4A, the spatial light modulator 140 may be created by placing multiple phase masks (masks with a phase pattern that is able to generate a Bessel beam) capable of replacing the axicon lens AL of the single Bessel beam generation part 120, and may separate the organized line beam into four or multiple Bessel beams so that the organized line beam is converted in the form of the multiple Bessel beams expanded in the z-direction.

The y-direction scan mirror 150 may perform the high-speed y-axis scanning of the converted multiple Bessel beams and may transform the converted multiple Bessel beams into a two-dimensional Bessel sheet beam.

The y-direction scan mirror 150 may generate a light sheet by scanning four or multiple excitation Bessel beams together, thereby linearly increasing time for which the multiple Bessel beams stay at each pixel.

There is the effects of improving fluorescence efficiency, and increasing sensitivity and imaging speed, compared to the single Bessel beam generation part 120 in which when using a single Bessel beam, the single Bessel beam is scanned, and thus a scanning range that needs to be scanned is wide, and time for which the Bessel beam stays at each point of the sample is short, resulting in relatively low fluorescence efficiency.

In this case, time required for scanning is proportional to time for which the Bessel beam stays in a pixel and the total number of pixels, and inversely proportional to the number of Bessel beams.

The specific configuration of the image acquisition part 200 of FIGS. 4A and 4B is the same as the description thereof described above in the first embodiment according to FIG. 1 and thus will be replaced with the description in the first embodiment.

FIG. 5 is a diagram schematically illustrating the configuration and arrangement of an open-top two-photon light sheet microscope according to the third embodiment of the present disclosure. Referring to FIG. 5, the laser irradiation part 100 of the open-top two-photon light sheet microscope according to the third embodiment of the present disclosure may include the first objective lens 410, and the image acquisition part 200 may include a second objective lens 420, wherein the first objective lens 410 and the second objective lens 420 may be arranged to be non-orthogonal to each other (at an acute angle).

The second objective lens 420 may be arranged perpendicularly based on the surface of the sample, which ensures the maximum depth of imaging.

In this case, due to the non-orthogonal arrangement of the first objective lens 410 and the second objective lens 420, the reaction beam generated from the sample is inclined to the focal plane of the second objective lens 420. Accordingly, the image acquisition part 200 may have a different configuration of an optical system by including the restoration module 600 which is capable of returning the distorted image to an original state thereof.

The image acquisition part 200 may include the restoration module 600 which restores the tilted image plane of the reaction beam generated from the sample, the dichroic mirror 210 that separates the reaction beam passing through the restoration module 600 into the two-photon fluorescence signal and the second harmonic signal, the two-photon fluorescence signal image acquisition part 220 which receives the two-photon fluorescence signal passing through the dichroic mirror 210, and the second harmonic signal image acquisition part 230 which receives the second harmonic signal reflected from the dichroic mirror 210.

The restoration module 600 may perform a function (remote focusing) to restore the tilted focal plane or image plane of the reaction beam passing through the second objective lens 420, and may include a polarizing beam separator 610, a quarter wave plate 620, a transmission objective lens 440, and a second prism mirror 520.

The polarizing beam separator 610 may separate the incident light that has passed through the second objective lens into two beams according to polarization so as to allow the two beams to pass and be reflected.

The quarter wave plate 620 may change the polarization state of light passing through the polarizing beam separator 610, and the transmission objective lens 440 enables light passing through the quarter wave plate 620 to obtain a high numerical aperture.

The second prism mirror 520 again irradiates the dichroic mirror 210 with an image plane restored through the restoration module 600 again to through the transmission objective lens 440, the quarter wave plate 620, and the polarizing beam separator 610.

The non-orthogonal (an acute angle, a form in which the second objective lens looks perpendicularly at the sample) arrangement of the first objective lens 410 and the second objective lens 420 may overcome the problem of an actual imaging depth being expressed to be shallow, compared to the penetration path of a reaction beam. That is, the non-orthogonal arrangement may improve the depth of imaging by allowing the penetration path of the reaction beam to become the actual imaging depth.

The detailed description of each step below is the same as the description described above in the first and second embodiments of FIGS. 1 and 3, and thus will be replaced with the description in the first and second embodiments.

FIG. 6 is a diagram schematically illustrating the configuration and arrangement of an open-top two-photon light sheet microscope according to a fourth embodiment of the present disclosure. Referring to FIG. 6, the laser irradiation part 100 and the image acquisition part 200 of the open-top two-photon light sheet microscope according to the fourth embodiment of the present disclosure may share one single objective lens 430.

In this case, the laser irradiation part 100 may use only a partial focal region of the single objective lens 430.

The single objective lens 430 as a device allows a laser beam generated from the laser irradiation part 100 and a reaction beam to be acquired by the image acquisition part 200 to pass therethrough.

In addition, the laser irradiation part 100 and the image acquisition part 200 may share one single objective-lens dichroic mirror 210.

The single objective-lens dichroic mirror 210′ as a device may differently process a laser beam generated from the laser irradiation part 100 and a reaction beam to be acquired by the image acquisition part 200. In an embodiment, the single objective-lens dichroic mirror 210 may be a short-pass filter and may a laser beam with a relatively long wavelength to be reflected therefrom and a reaction beam with a relatively short wavelength to pass therethrough.

In this case, the specification of the single objective-lens dichroic mirror 210′ may vary depending on the wavelength bands of the laser beam and reaction beam.

The image acquisition part 200 may collect a reaction beam while the single objective lens 430 faces the front surface of the sample for the same reason as the non-orthogonal arrangement of the first objective lens 410 and the second objective lens 420 described above in the third embodiment of FIG. 5.

In the fourth embodiment of FIG. 6, light sheet generation and imaging may be simultaneously performed only with one single objective lens 430, and accordingly, the device configuration of a system is simple compared to the first to third embodiments of FIGS. 1, 3, and 5 in which the two objective lenses are used, and interference with a tissue sample caused by different angles of the two objective lenses is avoided, and imaging through direct contact therewith is possible.

The detailed description of each step below is the same as the description described above in the first to third embodiments of FIGS. 1, 3, and 5, and thus here will be replaced with the description in the first to third embodiments.

The expression process and effects of the two-photon fluorescence signal and the second harmonic signal will be described with reference to FIGS. 8A and 8B below.

Referring to FIG. 8A, two excitation photons may increase the energy level of electrons within a fluorescent material molecule from a ground state to an excited state for the expression of a two-photon fluorescence signal.

The two excitation photons that have risen may perform two-photon excitation fluorescence, which emits fluorescence photons while lowering the energy level of electrons from the excited state back to the ground state. Here, the two-photon excitation fluorescence refers to a phenomenon in which the two excitation photons are absorbed and one fluorescence photon is emitted.

Since the two-photon excitation is a nonlinear excitation, there is little influence of side lobes (incidental lobes that occur on a side in a direction in which a Bessel beam is maximized) on the progression of the Bessel beam, thereby maximizing the non-diffraction characteristics of the Bessel beam.

Referring to FIG. 8B, two identical excitation photons may increase an energy level from a ground state to a virtual state (an intermediate state) through a nonlinear process for the expression of the second harmonic signal.

The second harmonic signal may be emitted with twice the energy of an initial excitation photon when the rising excitation photon falls back from the virtual state.

The expression of the second harmonic signal, which is a non-invasive imaging technique for measuring an optical signal emitted by a specific molecular structure, may distinguish between different types of connective tissues and, in particular, may be used to image the structure and density of collagen fibers.

The two-photon fluorescence signal allows cellular information of the sample to be obtained, and the second harmonic signal allows collagen information in the extracellular matrix of the sample to be obtained.

The second harmonic signal may be useful for lesion detection by visualizing changes in collagen distribution and fibrosis in lesions compared to normal tissue, enabling analysis of extracellular matrix changes and precise diagnosis through multi-contrast imaging.

Referring to FIG. 9, the operating method of the open-top two-photon light sheet microscope includes a laser beam irradiation step S100 of irradiating a sample with a laser beam, and an image acquisition step S200 by the image acquisition part 200 receiving a two-photon fluorescence signal and a second harmonic signal generated by the irradiating laser beam, wherein the laser beam irradiation step S100 includes a laser beam generation step S110 by the light source part 110, a single Bessel beam generation step S120 or a multiple Bessel beam generation step S130 by a single Bessel beam generation part 120 or a multiple Bessel beam generation part 130 converting the laser beam generated in the laser beam generation step S110 into a single Bessel beam or multiple Bessel beams, and a scanning step by the y-direction scan mirror 150 generating a single Bessel sheet beam or multiple Bessel sheet beams by scanning the single Bessel beam or the multiple Bessel beams converted in the single Bessel beam generation step S120 or the multiple Bessel beam generation step S130 in the y direction in S140, wherein the image acquisition step S200 may include an image separation step S210 by the dichroic mirror 210 separating a reaction beam passing through the second objective lens into the two-photon fluorescence signal and the second harmonic signal, a two-photon fluorescence signal image acquisition step S220 by the two-photon fluorescence signal image acquisition part 220 receiving the two-photon fluorescence signal passing through the dichroic mirror 210, and a second harmonic signal image acquisition step S230 by the second harmonic signal image acquisition part 230 receiving the second harmonic signal reflected from the dichroic mirror 210.

The detailed description of each of the steps is the same as the description of the above device, and thus will be replaced with the above description.

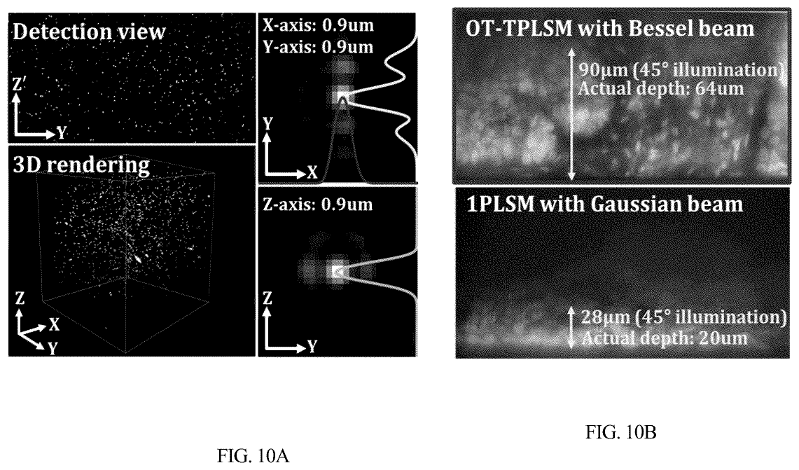

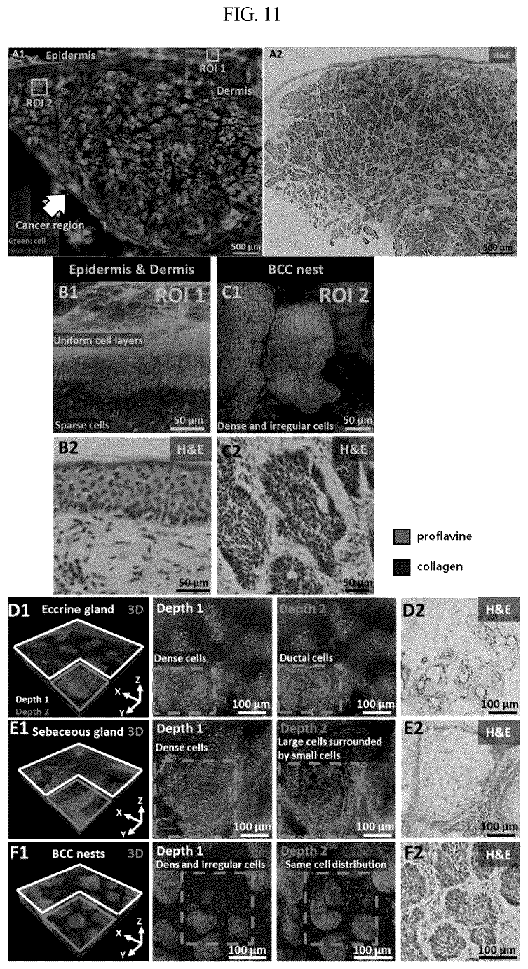

Next, referring to FIGS. 10A, 10B, and FIG. 11, an embodiment of the open-top two-photon light sheet microscope according to the first embodiment of the present disclosure will be described.

FIGS. 10A and 10B are images illustrating an embodiment of a microspheres and human skin tissue obtained by the open-top two-photon light sheet microscope according to the first embodiment of the present disclosure. FIG. 10A is an image illustrating an embodiment of a three-dimensional microsphere obtained in the first embodiment of the present disclosure, and FIG. 10B is an image illustrating the first embodiment of the present disclosure and an embodiment of the depth of human skin tissue acquired by a microscope using a single photon.

Referring to FIG. 10A, the open-top two-photon light sheet microscope according to the first embodiment of the present disclosure may first photograph microspheres with refractive indices matched, set a performance test and resolution, and then observe human skin tissue, so that a 3D image in the x-axis, y-axis, and z-axis directions is obtained. In this case, the image may have a resolution of 0.9 μm in all directions of the x-axis, y-axis, and z-axis, and proflavine is used for cell staining of skin tissue.

In addition, referring to FIG. 10B, the open-top two-photon light sheet microscope according to the first embodiment of the present disclosure may acquire images of the sample up to a depth of 90 μm from the surface of the sample. The depth is the moving distance of a laser beam with which the sample is irradiated, and in this case, the depth from the sample surface located perpendicular to the horizon is 64 μm.

On the other hand, a microscope using a single photon may acquire images of the sample up to a depth of 28 μm from the surface of the sample, and in this case, the depth from the sample surface located perpendicular to the horizon is 20 μm.

Accordingly, the open-top two-photon light sheet microscope according to the first embodiment of the present disclosure uses a two-photon laser beam, which allows for improved imaging depth by about 3 times compared to a microscope using a single photon, thereby enabling deeper portion inside the sample to be observed.

FIG. 11 illustrates images of an embodiment of basal cell carcinoma tissue of human skin obtained by using the open-top two-photon light sheet microscope according to the first embodiment of the present disclosure or a conventional histopathological examination method, wherein A1 to F1 are examples of images acquired by the open-top two-photon light sheet microscope according to the first embodiment of the present disclosure, and A2 to F2 are examples of images acquired by using a histopathological examination method.

In this case, A2 to F2 are images corresponding to A1 to F1, and proflavine is used for cell staining of skin tissue.

Referring to A1 to F1 of FIG. 11, the open-top two-photon light sheet microscope according to the first embodiment of the present disclosure simultaneously photographs basal cell carcinoma tissue through fluorescence and second harmonic channels, so a two-photon fluorescence image and a second harmonic signal image may be obtained to be distinct from each other. The two-photon fluorescence image represents a proflavine fluorescence signal, and the second harmonic signal image represents collagen.

Referring to A1 and A2 of FIG. 11, in an embodiment of the basal cell carcinoma tissue, thin undamaged epidermis on an upper end of the tissue and a cancer region in dermis in which basal cell carcinoma masses are clustered at a high density at a lower end thereof can be seen. As illustrated in A1 of FIG. 11, since the dermis has a much higher collagen content than the epidermis, the dermis and epidermis may be distinguished from each other based on collagen contrast.

B1, B2, C1, and C2 of FIG. 11 are examples of enlarged images of the epidermal region ROI 1 and cancer area ROI 2 of A1 and A2 of FIG. 11.

Referring to B1 and B2 of FIG. 11, an epidermal region ROI 1 has cells uniformly distributed, and is composed of cell layers of various sizes especially as shown in B1 of FIG. 11.

Referring to C1 and C2 of FIG. 11, in the cancer area ROI 2, cells of similar size are distributed irregularly and densely, and collagen is distributed between cancer masses as shown in C1 of FIG. 11.

That is, the open-top two-photon light sheet microscope according to the first embodiment of the present disclosure is capable of checking not only the distribution of cells that can be observed by using existing pathological biopsies, but also the distribution of various cell layers or collagen.

D1 to F1 and D2 to F2 in FIG. 11 are examples of three-dimensional images and depth-specific images of normal sweat glands, normal sebaceous glands, and cancer cell structures.

Referring to D1 and E1 of FIG. 11, the normal sweat glands have a single cell layer formed as ductal cells inside the dense cell structure, and the normal sebaceous glands are formed in structure in which cells (large cells) distributed in a center thereof are surrounded by relatively small cells. Referring to F1 and F2 of FIG. 11, the cancer cell structure has an uneven and highly dense cell distribution both on the surface (depth 1) and inside (depth 2).

When observing only the surface (depth 1) of each of the normal sweat glands and normal sebaceous glands, cells are distributed unevenly and densely, and thus the cells and the cancer cell structures are difficult to be distinguished from each other, but may be clearly distinguished from each other through 3D imaging.

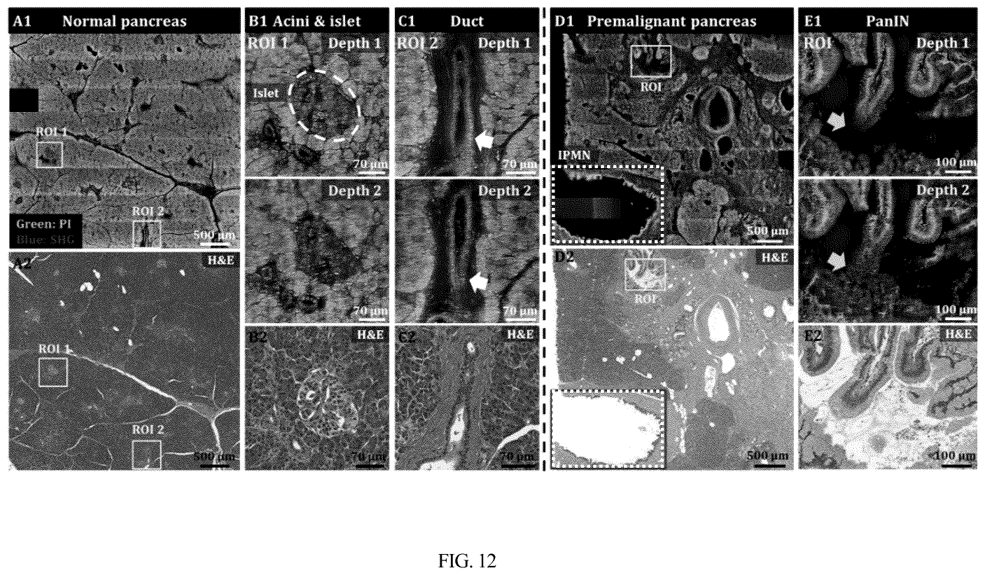

FIG. 12 illustrates images of an embodiment of the normal pancreas and premalignant pancreas of a person obtained by the open-top two-photon light sheet microscope according to the first embodiment of the present disclosure. A1 to E1 of FIG. 12 illustrate an embodiment of images obtained by the open-top two-photon light sheet microscope according to the first embodiment of the present disclosure, and A2 to E2 of FIG. 12 illustrates an embodiment of images obtained by using a conventional histopathological examination method in locations or regions corresponding to A1 to E1.

In this case, cell staining uses propidium iodide (PI), and a propidium iodide fluorescence signal is expressed in a green color (a relatively bright color in a black-and-white image) and a collagen signal is expressed in a blue color (a color darker than the fluorescence signal in a black-and-white image, with separate white hatches), respectively.

Referring to A1 and A2 of FIG. 12, the normal pancreas has structures densely packed with acini cells distributed throughout. Particularly, referring to A1 of FIG. 12, the acini cells (not shown in A2 of FIG. 12) have collagen distributed between the acini cell structures.

B1 and B2 of FIG. 12 are examples of enlarged images of the acini cells and region ROI 1 of islet of Langerhans of A1 and A2 of FIGS. 12, and C1 and C2 of FIG. 12 are examples of enlarged images of the regions ROI 2 of duct structure of A1 and A2 of FIG. 12.

Referring to B1 and B2 of FIG. 12, in the acini cells, both the nucleus and cytoplasm of each of the cells are observed, but the islet of Langerhans located between the structures of the acini cells is distinguished by a relatively low fluorescence signal as illustrated in B1 of FIG. 12.

Referring to C1 and C2 of FIG. 12, the duct structure is a single cell layer, and particularly, it may be known that referring to the depth image of C1, the three-dimensional structure (a white arrow) of the duct is seen, and collagen is distributed around the three-dimensional structure.

Referring to D1 and D2 of FIG. 12, the premalignant pancreas has pancreatic intraepithelial neoplasia (PanIN) and intraductal papillary mucinous neoplasm (IPMN) with irregular morphologies distributed, and has more collagen distributed, compared to normal cells illustrated in A1 of FIG. 12.

E1 and E2 of FIG. 12 are examples of enlarged images of the regions ROI of the pancreatic intraepithelial neoplasia of D1 and D2 of FIG. 12. Referring to E1 and E2 of FIG. 12, in the premalignant pancreas, cells are distributed unevenly, and particularly, referring to E1 of FIG. 12, the three-dimensional structure (a gray arrow) is confirmed through the depth image of the neoplasia.

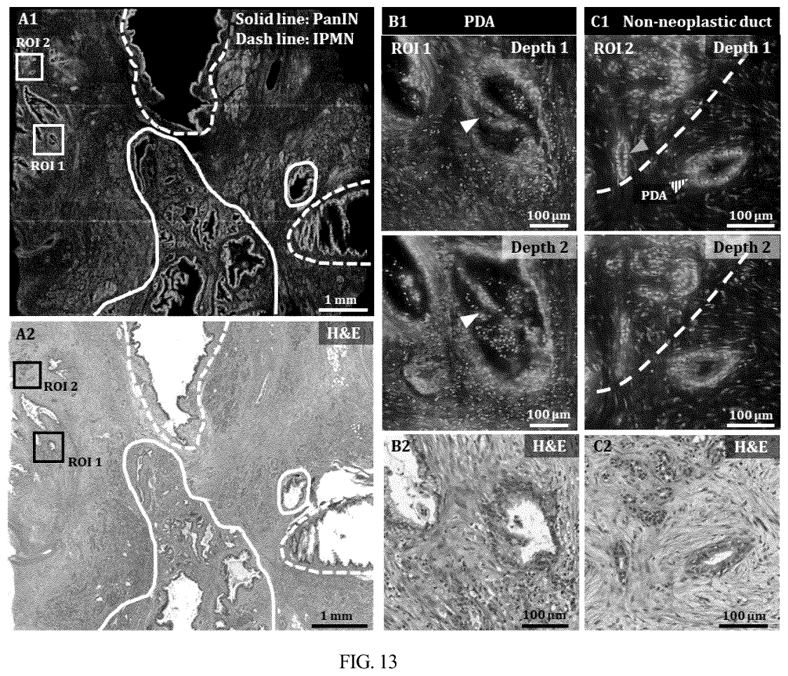

FIG. 13 illustrates images of an embodiment of premalignant pancreas and pancreatic ductal adenocarcinoma (PDA) tissue obtained by the open-top two-photon light sheet microscope according to the first embodiment of the present disclosure. A2 to C2 of FIG. 13 illustrate an embodiment of histopathological examination images at the same locations as the image regions of A1 to C1 of FIG. 13.

In this case, cell staining uses propidium iodide, and a propidium iodide fluorescence signal and a collagen signal are respectively expressed in a green color (a relatively bright color in a black-and-white image) and a blue color (a relatively dark color in a black-and-white image).

Referring to A1 and A2 of FIG. 13, in the pancreatic ductal adenocarcinoma tissue, there are few normal acini cell structures, and uneven glandular structures of various sizes are distributed together with the high collagen distribution, particularly, referring to A1 of FIG. 13.

B1, B2, C1, and C2 of FIG. 13 are examples of enlarged images of the pancreatic ductal adenocarcinoma region ROI 1 of A1 and A2 of FIG. 13 and the non-neoplastic duct region ROI 2 of pancreatitis.

Referring to B1 and B2 of FIG. 13, the adenocarcinoma cells in the adenocarcinoma region have irregular arrangements and shapes of cells or fibrous structures, and display a tissue environment undergoing infiltration. Referring to B1 of FIG. 13, a complex three-dimensional structure including papillary projection (a white arrow) is formed.

Referring to C1 of FIG. 13, a non-neoplastic duct in pancreatitis (a gray arrow) is configured as a uniform single-cell layer structure, and a cancer structure (a hatched arrow, PDA) has a non-uniform cell distribution, unlike the single cell layer structure.

These are not seen in a histopathological examination image in which depth-specific images illustrated in C2 of FIG. 13 are not captured.

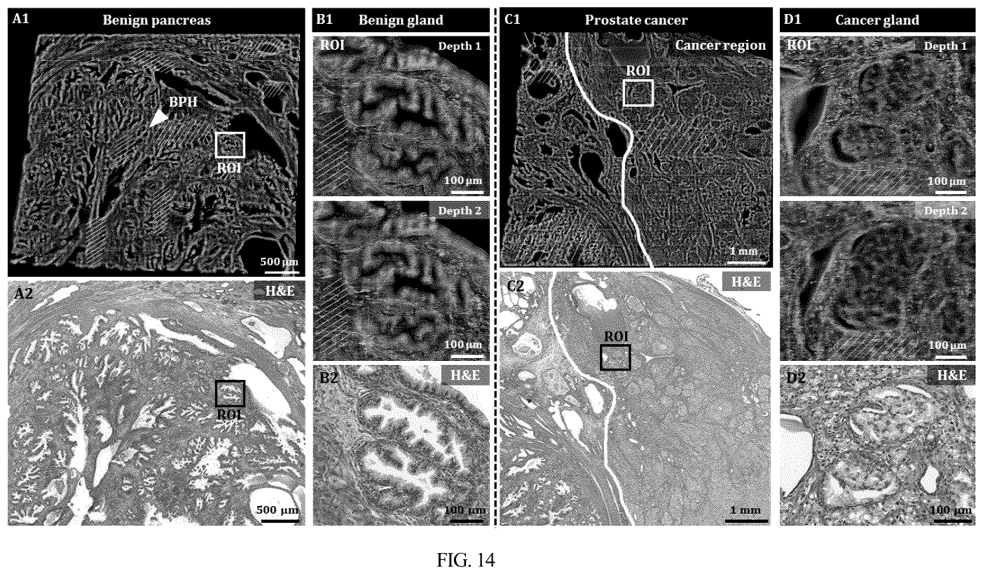

FIG. 14 is an image illustrating an embodiment of the benign prostate and prostate adenocarcinoma tissue of a person obtained by using the open-top two-photon light sheet microscope according to the first embodiment of the present disclosure, and A2 to D2 are embodiments of histopathological examination images at the same locations as the image regions of A1 to D1.

In this case, cell staining uses propidium iodide, and a propidium iodide fluorescence signal and a collagen signal are respectively expressed in a green color (a relatively bright color in a black-and-white image) and a blue color (a relatively dark color in a black-and-white image, with separate white hatches).

Referring to A1 and A2 of FIG. 14, the benign prostate has secretory glands distributed uniformly, and referring to A1 of FIG. 14, collagen is distributed around the glands.

B1 and B2 of FIG. 14 are an embodiment of enlarged images of the benign secretion glandular regions (ROI) of A1 and A2. Referring to B1 of FIG. 14, the human benign prostate has a three-dimensional cellular structure composed of multiple cell layers.

Referring to C1 and C2 of FIG. 14, the prostate cancer tissue includes benign prostate (at a left side) and prostate adenocarcinoma (at a right side, a cancer region) which coexist. Particularly, referring to C1 of FIG. 14, the prostate adenocarcinoma has relatively less collagen (white oblique lines) distributed compared to the benign prostate.

D1 and D2 of FIG. 14 is an embodiment of an enlarged image of a prostate adenocarcinoma region (ROI) of C1 and C2. Referring to D1 and D2 of FIG. 14, in the prostate adenocarcinoma, cancer cells are irregularly distributed within a cancer structure, and many cancer cells are distributed around the cancer structure due to infiltration.

In addition, referring to D1 of FIG. 14, the prostate adenocarcinoma is formed in a structure in which cancer structures that are divided into two structures on a tissue surface are coupled to each other at a position deeper than the tissue surface.

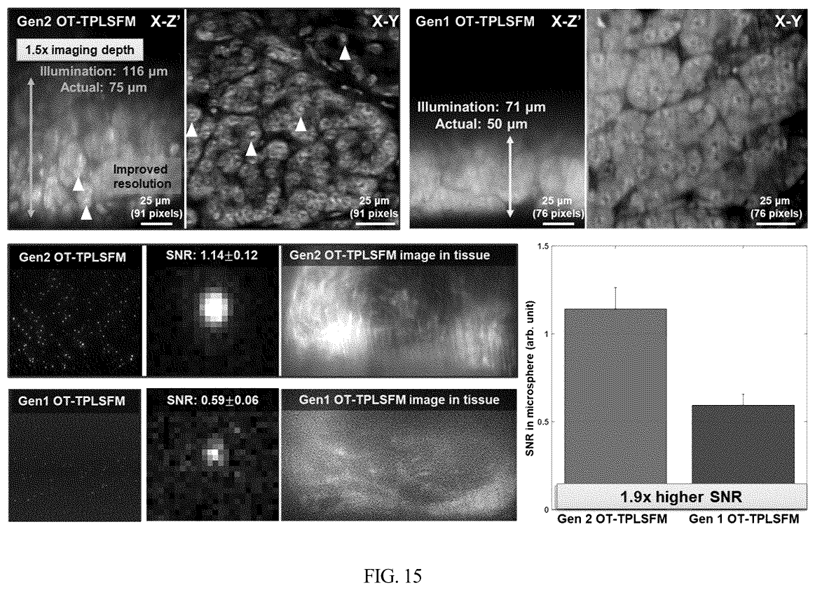

Next, an embodiment of the open-top two-photon light sheet microscope according to the third embodiment of the present disclosure will be described with reference to FIG. 15.

FIG. 15 illustrates images of an embodiment of pancreatic tissue obtained by the open-top two-photon light sheet microscope according to the first embodiment or the third embodiment of the present disclosure.

First, the open-top two-photon light sheet microscope according to the third embodiment of the present disclosure has a non-orthogonal configuration with multiple Bessel beam scanning, and may output providing high depth and high contrast images, compared to a microscope using a single photon or single Bessel beam.

The first objective lens 410 disposed non-orthogonally (40° wrt with respect to the surface of a sample) to the second objective lens 420 arranged perpendicularly to the ground toward the sample may have a magnification of 10×0.28 NA, and may convert a laser beam output from the light source part 110 into a two-photon excitation light sheet (multiple Bessel beams) with 4×1 Bessel beam scanning.

In this case, the multiple Bessel beams may be generated by the spatial light modulator 140 and scanned by a galvano mirror scanner, i.e. the y-direction scan mirror 150, wherein the multiple Bessel beam scanning has a pixel duration which is 4 times longer than single Bessel beam scanning.

The second objective lens 420 may have a magnification of 20×0.6NA, and is oriented perpendicularly to the sample to collect a reaction beam formed in the sample by a minimal path.

Referring to FIG. 15, the open-top two-photon light sheet microscope according to the third embodiment of the present disclosure may capture images up to 75 μm deep from the surface of the sample when photographing human pancreatic tissue. This represents the interior of the sample, which is approximately 1.5 times deeper than a 50 μm-depth image from the surface of the sample that can be obtained when the two objective lenses are oriented perpendicular to each other (see FIG. 1, the first embodiment of the present disclosure).

In addition, the open-top two-photon light sheet microscope according to the third embodiment of the present disclosure may visualize information inside cells in more detail by outputting images with improved resolution than when two objective lenses are oriented perpendicularly to each other, wherein an SNR (signal-to-noise), which distinguishes between a desired signal and other signals, is 1.14±0.12, which is about 1.9 times better than when the two objective lenses are oriented perpendicularly to each other.

As described above, preferred embodiments of the present disclosure are illustrated and described with reference to the drawings, but the present disclosure is not limited to the specific embodiments described above. Various modifications may be made by a person with ordinary knowledge in the technical field to which the present disclosure pertains without departing from the gist of the present disclosure as claimed in the claims. These modifications should not be understood individually from the technical idea or perspective of the present disclosure.

What is claimed is:

1. An open-top two-photon light sheet microscope comprising:
a laser irradiation part configured to irradiate a sample with a two-photon excitation laser beam; and
an image acquisition part configured to receive a two-photon fluorescence signal and a second harmonic signal generated by the irradiating laser beam,
wherein the laser irradiation part comprises a single Bessel beam generation part configured to generate a single Bessel beam or a multiple Bessel beam generation part configured to generate multiple Bessel beams.

2. The microscope of claim 1, wherein the laser irradiation part comprises a first objective lens, and the image acquisition part comprises a second objective lens,
wherein the first objective lens and the second objective lens are orthogonal to each other.

3. The microscope of claim 1, wherein the laser irradiation part comprises a first objective lens, and the image acquisition part comprises a second objective lens,
wherein the first objective lens and the second objective lens are arranged to be non-orthogonal to each other.

4. The microscope of claim 2, wherein the single Bessel beam generation part comprises:
a light source part configured to generate a laser beam;
an axicon lens configured to convert the laser beam generated from the light source part into the single Bessel beam; and
a y-direction scan mirror configured to generate a Bessel sheet beam by scanning the single Bessel beam converted from the axicon lens in a y direction.

5. The microscope of claim 4, wherein the image acquisition part comprises:
a dichroic mirror configured to receive a reaction beam generated from the sample and separate the reaction beam into the two-photon fluorescence signal and the second harmonic signal;
a two-photon fluorescence signal image acquisition part configured to receive the two-photon fluorescence signal passing through the dichroic mirror; and
a second harmonic signal image acquisition part configured to receive the second harmonic signal reflected from the dichroic mirror.

6. The microscope of claim 2, wherein the multiple Bessel beam generation part comprises:
a light source part configured to generate a laser beam;
a first cylindrical lens configured to convert a point-shaped laser beam generated from the light source part into a line-shaped beam;
a second cylindrical lens configured to organize the converted line-shaped beam into a collimated beam;
a spatial light modulator configured to convert the collimated line-shaped beam into the multiple Bessel beams; and
a y-direction scan mirror configured to generate multiple Bessel sheet beams by scanning the converted multiple Bessel beams in a y direction.

7. The microscope of claim 6, wherein the image acquisition part comprises:
a dichroic mirror configured to receive a reaction beam generated from the sample and separate the reaction beam into the two-photon fluorescence signal and the second harmonic signal;
a two-photon fluorescence signal image acquisition part configured to receive the two-photon fluorescence signal passing through the dichroic mirror; and
a second harmonic signal image acquisition part configured to receive the second harmonic signal reflected from the dichroic mirror.

8. The microscope of claim 3, wherein the multiple Bessel beam generation part comprises:
a light source part configured to generate a laser beam;
a first cylindrical lens configured to convert a point-shaped laser beam generated from the light source part into a line-shaped beam;
a second cylindrical lens configured to organize the converted line-shaped beam into a collimated beam;
a spatial light modulator configured to convert the collimated line-shaped beam into the multiple Bessel beams; and
a y-direction scan mirror configured to generate multiple Bessel sheet beams by scanning the converted multiple Bessel beams in a y direction.

9. The microscope of claim 8, wherein the image acquisition part comprises:
a restoration module configured to restore a tilted image plane of a reaction beam generated from the sample;
a dichroic mirror configured to separate the reaction beam passing through the restoration module into the two-photon fluorescence signal and the second harmonic signal;
a two-photon fluorescence signal image acquisition part configured to receive the two-photon fluorescence signal passing through the dichroic mirror; and
a second harmonic signal image acquisition part configured to receive the second harmonic signal reflected from the dichroic mirror.

10. The microscope of claim 1, wherein the laser irradiation part and the image acquisition part share one single objective lens.

11. The microscope of claim 10, wherein the laser irradiation part uses only a partial focal region of the single objective lens.

12. The microscope of claim 11, wherein the multiple Bessel beam generation part comprises:
a light source part configured to generate a laser beam;
a first cylindrical lens configured to convert a point-shaped laser beam generated from the light source part into a line-shaped beam;
a second cylindrical lens configured to organize the converted line-shaped beam into a collimated beam;
a spatial light modulator configured to convert the collimated line-shaped beam into the multiple Bessel beams; and
a y-direction scan mirror configured to generate multiple Bessel sheet beams by scanning the converted multiple Bessel beams in a y direction.

13. The microscope of claim 10, wherein the image acquisition part comprises:
a restoration module configured to restore a tilted image plane of a reaction beam generated from the sample;
a dichroic mirror configured to separate the reaction beam passing through the restoration module into the two-photon fluorescence signal and the second harmonic signal;
a two-photon fluorescence signal image acquisition part configured to receive the two-photon fluorescence signal passing through the dichroic mirror; and
a second harmonic signal image acquisition part configured to receive the second harmonic signal reflected from the dichroic mirror.

14. The microscope of claim 1, further comprising:
a sample holder configured to hold the sample; and
a motorized stage configured to transport the sample holder in an x direction,
wherein the sample holder comprises a liquid prism to eliminate an off-axis optical aberration.

15. An operating method of an open-top two-photon light sheet microscope, the method comprising:
a laser beam irradiation step of irradiating a sample with a laser beam; and
an image acquisition step by an image acquisition part receiving a two-photon fluorescence signal and a second harmonic signal generated by the irradiating laser beam,
wherein the laser beam irradiation step comprises:
a laser beam generation step by a light source part generating a laser beam;
a single Bessel beam generation step or a multiple Bessel beam generation step by a single Bessel beam generation part or a multiple Bessel beam generation part converting the laser beam generated in the laser beam irradiation step into a single Bessel beam or multiple Bessel beams; and
a scanning step by a y-direction scan mirror generating a single Bessel sheet beam or multiple Bessel sheet beams by scanning the single Bessel beam or the multiple Bessel beams converted in the single Bessel beam generation step or the multiple Bessel beam generation step in a y direction,
wherein the image acquisition step comprises:
an image separation step by a dichroic mirror separating a reaction beam passing through a second objective lens into the two-photon fluorescence signal and the second harmonic signal;
a two-photon fluorescence signal image acquisition step by a two-photon fluorescence signal image acquisition part receiving the two-photon fluorescence signal passing through the dichroic mirror; and
a second harmonic signal image acquisition step by a second harmonic signal image acquisition part receiving the second harmonic signal reflected from the dichroic mirror.
